(19) United States
(12) Patent Application Publication
(10) Pub. No.: US 2024/0084467 A1
(43) Pub. Date: Mar. 14, 2024

(54) SYSTEMS AND METHODS FOR MAXIMIZING HYDROGEN PRODUCTION FROM RENEWABLE ENERGY SOURCES

(71) Applicants: CUMMINS INC., Columbus, IN (US); HYDROGENICS CORPORATION, Mississauga (CA)

(72) Inventors: Dustin VICKRESS, Mississauga (CA); Richard J. ANCIMER, Toronto (CA); Joseph P. CHANDRARAJ, Austin, TX (US); Joseph CARGNELLI, Toronto (CA)

(21) Appl. No.: 18/460,333

(22) Filed: Sep. 1, 2023

Related U.S. Application Data
(60) Provisional application No. 63/404,805, filed on Sep. 8, 2022.

(51) Int. Cl. C25B 15/029; C25B 1/04; C25B 9/65; C25B 9/70; H02J 3/00

(52) U.S. Cl. CPC C25B 15/029; C25B 1/04; C25B 9/65; C25B 9/70; H02J 3/004

(57) ABSTRACT

The present disclosure relates to systems and methods to forecast changes in renewable energy availability to maximize hydrogen production by electrolysis systems over a period of renewable energy availability. The present disclosure relates to a method of utilizing variable energy including using a look-ahead forecast model, which provides an assessment of available renewable energy. The present disclosure relates to a method of operating of one or more electrolyzer cell stacks in an electrolysis system to produce hydrogen by using the look-ahead forecast model in real-time.

### CROSS-REFERENCE TO RELATED APPLICATIONS

This nonprovisional application claims the benefit and priority, under 35 U.S.C. § 119(e) and any other applicable laws or statutes, to U.S. Provisional Application Ser. No. 63/404,805 filed on Sep. 8, 2022, the entire disclosure of which is hereby expressly incorporated herein by reference.

### TECHNICAL FIELD

The present disclosure relates to electrolysis systems, in particular systems and methods for maximizing hydrogen production from electrolysis systems using renewable energy sources.

### BACKGROUND

Electrochemical cells and electrolytic cells use chemical reactions involving electricity. For example, a fuel cell uses hydrogen and oxygen to produce electricity. An electrolyzer uses water and electricity to produce hydrogen and oxygen.

The electrolyzer comprises one or more electrolytic cells that utilize electricity to chemically produce substantially pure hydrogen and oxygen from water. Often, the electrical source for the electrolyzer is produced from energy generation systems, including renewable energy systems, such as from wind, solar, hydroelectric, and/or geothermal sources. In turn, the pure hydrogen produced by the electrolyzer is often utilized as a fuel or energy source for those same energy generation systems, such as fuel cell systems.

The typical electrolytic cell, also referred to as an “electrolyzer cell,” is comprised of many assemblies compressed and bound into a stack. An electrolytic cell includes a multi-component membrane electrode assembly (MEA) that has an anode, a cathode, and an electrolyte. Typically, the anode, cathode, and electrolyte of the membrane electrode assembly (MEA) are configured in a multi-layer arrangement that enables the electrochemical reaction to produce hydrogen via contact with one or more gas diffusion layers. A gas diffusion layer (GDL) and/or a porous transport layer (PTL) is typically located on one or both sides of the MEA. Bipolar plates (BPP) often reside on either side of the GDLs and separate the individual electrolytic cells of the stack from one another.

Green hydrogen is produced using variable renewable energy (VRE) sources to support an electrolysis system. The variable renewable energy (VRE) sources produce energy intermittently instead of on demand. Thus, the availability of energy can vary through the day, week, and/or season. The variable renewable energy (VRE) can include sources of energy, such as from solar energy, wind energy, tidal energy, geothermal or hydroelectric energy.

Operating electrolysis systems may involve delays, including start-up delays. For example, stat-up delays may be associated with a dysfunction of hydrogen purification unit, compressors, and/or other downstream equipment. The start-up delays may also depend on the quality of hydrogen being produced.

Alternatively, the electrolyzer stacks or the electrolysis systems may be kept on standby in preparation for changes in VRE sources. However, keeping the electrolyzer stacks or the electrolysis systems on standby still uses energy. Furthermore, implementation of the electrolysis system(s) for any application requires coordination with equipment outages and/or scheduled preventative maintenance.

To overcome the challenges described above, the present disclosure provides systems and methods to forecast changes in renewable energy availability to maximize hydrogen production over an available period. The present disclosure provides systems and methods for implementing a look-ahead forecast model for hydrogen production.

### SUMMARY

Embodiments of the present disclosure are included to meet these and other needs.

In one aspect described herein, a method of utilizing variable renewable energy comprises using a look-ahead forecast model, which provides an assessment of available renewable energy, determining an operation of one or more electrolyzer cell stacks in an electrolysis system to produce hydrogen by a controller which uses the look-ahead forecast model in real-time, and determining a time range of operation of each of the one or more electrolyzer cell stacks in the electrolysis system.

In some embodiments, the look-ahead forecast model may be used to assess wind energy, solar energy, geothermal energy, hydro energy, or any combination thereof.

In some embodiments, the method may further comprise minimizing loss or missed production. In the first aspect of the present invention, minimizing loss may comprise minimizing energy loss. In some embodiments, minimizing missed production may comprise minimizing potential loss due to suboptimal implementation of the one or more electrolyzer cell stacks.

In some embodiments, the method may further comprise using the look-ahead forecast model for forecasting available variable energy over a period of about 14 days. In some embodiments, the method may further comprise the controller determining the operation of the one or more electrolyzer cell stacks based on a characteristic of the electrolysis system. The characteristic of the electrolysis system may include one or more of a capacity factor, a cost to produce hydrogen, and an availability of the electrolyzer cell stacks.

In some embodiments, the method may further comprise the controller determining the operation of the one or more electrolyzer cell stacks based on a constant hydrogen demand due to a designated process. In some embodiments, the method may further comprise the controller determining if excess hydrogen is being produced, and storing excess hydrogen produced in a hydrogen storage system. In some embodiments, the method may further comprise the controller determining if excess hydrogen is being produced based on the constant hydrogen demand due to the designated process.

In some embodiments, the method may further comprise the controller operating the one or more electrolyzer cell stacks in the electrolysis system based on the excess hydrogen stored in the hydrogen storage system.

In some embodiments, the method may further comprise the controller determining if insufficient hydrogen is being produced, and supplementing the hydrogen with stored hydrogen, or by adding electricity from a supplementary grid to produce a balance of hydrogen required. In some embodiments, the method may further comprise the controller determining if excess hydrogen is being produced based on the constant hydrogen demand due to the designated process, and minimizing utilizing supplementary grid if excess hydrogen is being produced. In the first aspect of the present invention, the method may further comprise the controller determining if excess hydrogen is being produced based on a downstream feedback from an equipment audit.

In some embodiments, downstream feedback from the equipment audit may comprise parameters including a capacity factor, a cost to produce hydrogen, an availability of the electrolyzer cell stacks, or amount of stored hydrogen.

In some embodiments, the method may further comprise the controller operating the one or more electrolyzer cell stacks to avoid a late start-up or to avoid missing out on the available renewable energy. In some embodiments, the method may further comprise the controller operating the one or more electrolyzer cell stacks to account for a change in renewable energy availability.

In a second aspect described herein, a system for utilizing available renewable energy comprises a controller in communication with a look-ahead forecast model, an electrolysis system including one or more electrolyzer stacks, and a hydrogen storage system to store any excess hydrogen produced. The operation of the one or more electrolyzer stacks is determined by the controller based on a look-ahead forecast model.

In some embodiments, the operation of the one or more electrolyzer stack in the system may be determined by the controller based on a constant hydrogen demand due to a designated process.

In some embodiments, the system may further comprises access to a power grid for the supply of supplementary power.

In some embodiments, the controller may further determine operation of the one or more electrolyzer cell stacks to account for changes in renewable energy availability.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1A is perspective view of an electrolyzer cell stack according to the present disclosure;

FIG. 1B is a schematic view of an electrolysis system configured to utilize the electrolyzer cells stack of FIG. 1A;

FIG. 1C is a schematic view of an additional portion of the electrolysis system of FIG. 1B;

FIG. 2 is a schematic showing an embodiment of a method utilizing a look-ahead forecast model to determine hydrogen production;

FIG. 3 is a schematic showing an embodiment of a method utilizing the look-ahead forecast model to determine hydrogen production based on a designated process demand;

FIG. 4A is a schematic showing missed production when the look-ahead forecast model is not used to change the operation of the electrolyzer cell modules; and

FIG. 4B is a schematic showing that the electrolyzer cell modules can be ramped-up or ramped-down in response to the look-ahead forecast model.

### DETAILED DESCRIPTION

The present disclosure provides systems and methods to forecast changes in renewable energy availability to maximize hydrogen production by electrolysis systems over a period of energy availability. Electrochemical cells and electrolytic cells provide chemical reactions that include electricity. For example, a fuel cell stack uses hydrogen and oxygen to produce electricity. An electrolyzer cell stack uses water and electricity to produce hydrogen and oxygen.

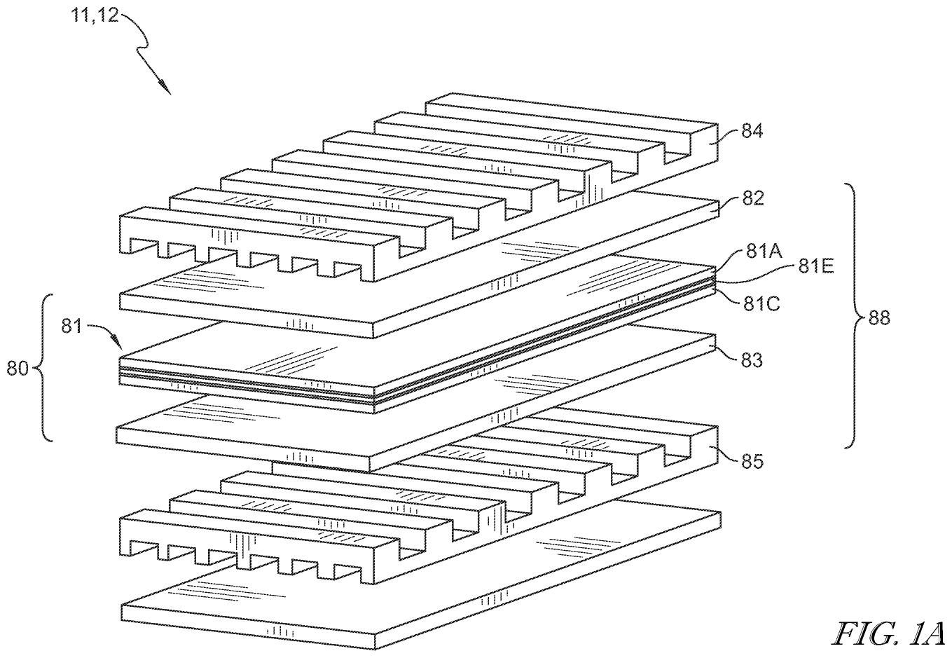

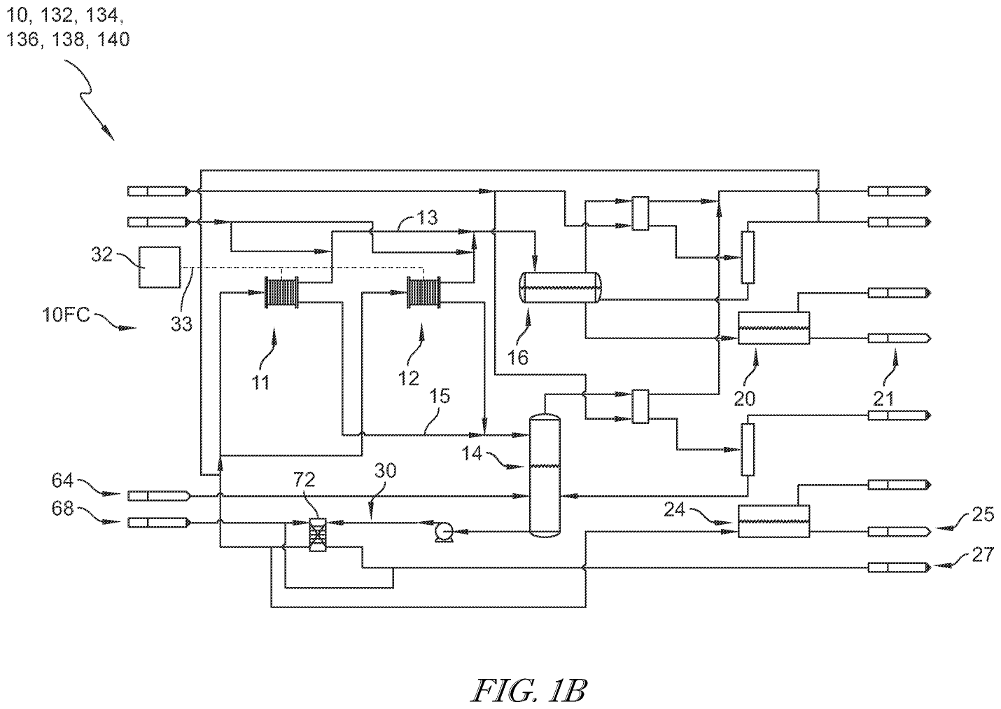

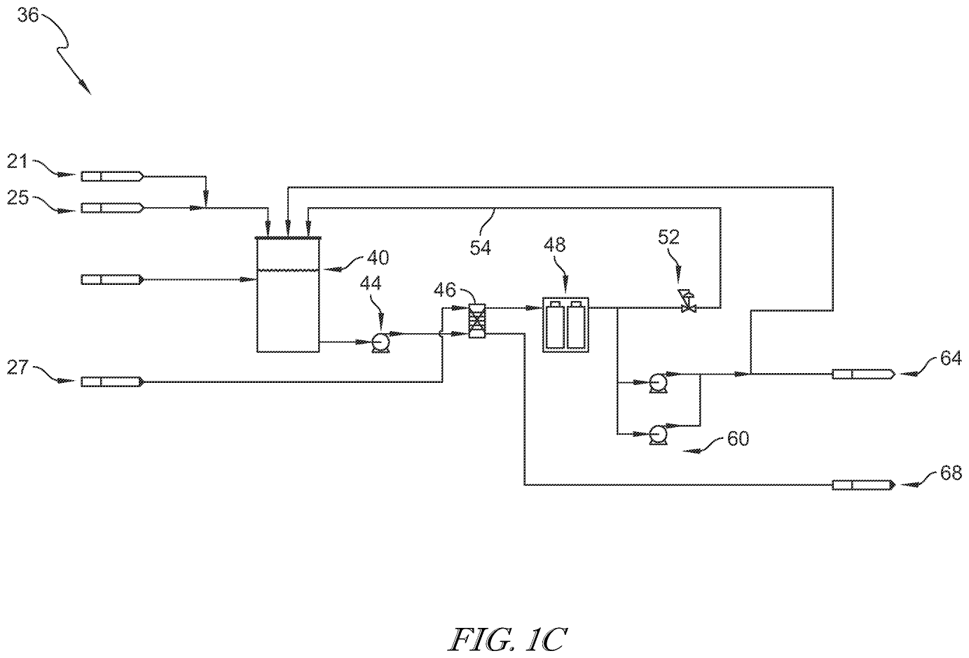

As shown in FIGS. 1A and 1B, electrolysis systems 10 are typically configured to utilize water and electricity to produce hydrogen and oxygen. An electrolysis system 10 typically includes one or more electrolyzer cells 80 that utilize electricity to chemically produce substantially pure hydrogen 13 and oxygen 15 from deionized water 30. Often the electrical source for the electrolysis systems 10 is produced from power or energy generation systems, including renewable energy systems such as wind, solar, hydroelectric, and geothermal sources for the production of green hydrogen. In turn, the pure hydrogen produced by the electrolysis systems 10 is often utilized as a fuel or energy source for those same power generation systems, such as fuel cell systems. Alternatively, the pure hydrogen produced by the electrolysis systems 10 may be stored for later use.

The typical electrolyzer cell 80, or electrolytic cell, is comprised of multiple assemblies compressed and bound into a single assembly, and multiple electrolyzer cells 80 may be stacked relative to each other, along with bipolar plates (BPP) 84, 85 therebetween, to form an electrolyzer cell stack (for example, electrolyzer cell stacks 11, 12 in FIG. 1B). Each electrolyzer cell stack 11, 12 may house a plurality of electrolyzer cells 80 connected together in series and/or in parallel. The number of electrolyzer cell stack 11, 12 in the electrolysis systems 10 can vary depending on the amount of power required to meet the power need of any load (e.g., fuel cell stack). The number of electrolyzer cells 80 in an electrolyzer cell stack 11, 12 can vary depending on the amount of power required to operate the electrolysis systems 10 including the electrolyzer cell stack 11, 12.

An electrolyzer cell 80 includes a multi-component membrane electrode assembly (MEA) 81 that has an electrolyte 81E, an anode 81A, and a cathode 81C. Typically, the anode 81A, cathode 81C, and electrolyte 81E of the membrane electrode assembly (MEA) 81 are configured in a multi-layer arrangement that enables the electrochemical reaction to produce hydrogen and/or oxygen via contact of the water with one or more gas diffusion layers 82, 83. The gas diffusion layers (GDL) 82, 83, which may also be referred to as porous transport layers (PTL), are typically located on one or both sides of the MEA 81. Bipolar plates (BPP) 84, 85 often reside on either side of the GDLs and separate the individual electrolyzer cells 80 of the electrolyzer cell stack 11, 12 from one another. One bipolar plate 85 and the adjacent gas diffusion layers 82, 83 and MEA 81 can form a repeating unit 88.

As shown in FIGS. 1B and 1C, an exemplary electrolysis system 10 can include two electrolyzer cell stacks 11, 12 and a fluidic circuit 10FC including the various fluidic pathways shown in FIGS. 1B and 1C that is configured to circulate, inject, and purge fluid and other components to and from the electrolysis systems 10. A person skilled in the art would understand that one or a variety of a number of components within the fluidic circuit 10FC, as well as more or less than two electrolyzer cell stacks 11, 12, may be utilized in the electrolysis systems 10. For example, the electrolysis systems 10 may include one electrolyzer cell stack 11, and in other examples, the electrolysis systems 10 may include three or more electrolyzer cell stacks.

The electrolysis systems 10 may include one or more types of electrolyzer cell stacks 11, 12 therein. In the illustrated embodiment, a polymer electrolyte membrane (PEM) electrolyzer cell 80 may be utilized in the stacks 11, 12. A PEM electrolyzer cell 80 typically operates at about 4° C. to about 150° C., including any specific or range of temperatures comprised therein. A PEM electrolyzer cell 80 also typically functions at about 100 bar or less, but can go up to about 1000 bar (including any specific or range of pressures comprised therein), which reduces the total energy demand of the system. A standard electrochemical reaction that occurs in a PEM electrolyzer cell 80 to produce hydrogen is as follows.

Anode: 2H₂O→O₂+4H⁺+4e⁻ (1)

Cathode: 4H⁺+4e⁻→2H₂ (2)

Overall: 2H₂O(liquid)→2H₂+O₂ (3)

Additionally, a solid oxide electrolyzer cell 80 may be utilized in the electrolysis systems 10. A solid oxide electrolyzer cell 80 will function at about 500° C. to about 1000° C., including any specific or range of temperatures comprised therein. A standard electrochemical reaction that occurs in a solid oxide electrolyzer cell 80 to produce hydrogen is as follows.

Anode: 2O²⁻→O₂+4e⁻ (4)

Cathode: 2H₂O→4e⁻+2H₂+2O²⁻ (5)

Overall: 2H₂O(liquid)→2H₂+O₂ (6)

Moreover, an AEM electrolyzer cell 80 may utilized, which uses an alkaline media. An exemplary AEM electrolyzer cell 80 is an alkaline electrolyzer cell 80. Alkaline electrolyzer cells 80 comprise aqueous solutions, such as potassium hydroxide (KOH) and/or sodium hydroxide (NaOH), as the electrolyte. Alkaline electrolyzer cells 80 typically perform at operating temperatures ranging from about 0° C. to about 150° C., including any specific or range of temperatures comprised therein. Alkaline electrolyzer cell 80 generally operate at pressures ranging from about 1 bar to about 100 bar, including any specific or range of pressures comprised therein. A typical hydrogen-generating electrochemical reaction that occurs in an alkaline electrolyzer cell 80 is as follows.

Anode: 4OH⁻→O₂+2H₂O+4e⁻ (7)

Cathode: 4H₂O+4e⁻→2H₂+4OH⁻ (8)

Overall: 2H₂O2H₂+O₂ (9)

As shown in FIG. 1B, the electrolyzer cell stacks 11, 12 include one or more electrolyzer cells 80 that utilize electricity to chemically produce substantially pure hydrogen and oxygen from water. In turn, the pure hydrogen produced by the electrolyzer may be utilized as a fuel or energy source. As shown in FIG. 1B, the electrolyzer cell stack 11, 12 outputs the produced hydrogen along a fluidic connecting line 13 to a hydrogen separator 16, and also outputs the produced oxygen along a fluidic connecting line 15 to an oxygen separator 14.

The hydrogen separator 16 may be configured to output pure hydrogen gas and also send additional output fluid to a hydrogen drain tank 20, which then outputs fluid to a deionized water drain 21. The oxygen separator 14 may output fluid to an oxygen drain tank 24, which in turn outputs fluid to a deionized water drain 25. A person skilled in the art would understand that certain inputs and outputs of fluid may be pure water or other fluids such as coolant or byproducts of the chemical reactions of the electrolyzer cell stacks 11, 12. For example, oxygen and hydrogen may flow away from the cell stacks 11, 12 to the respective separators 14, 16. The system 10 may further include a rectifier 32 configured to convert electricity 33 flowing to the cell stacks 11, 12 from alternating current (AC) to direct current (DC).

The deionized water drains 21, 25 each output to a deionized water tank 40, which is part of a polishing loop 36 of the fluidic circuit 10FC, as shown in FIG. 1C. Water with ion content can damage electrolyzer cell stacks 11, 12 when the ionized water interacts with internal components of the electrolyzer cell stacks 11, 12. The polishing loop 36, shown in greater detail in FIG. 1C, is configured to deionize the water such that it may be utilized in the cell stacks 11, 12 and not damage the cell stacks 11, 12.

In the illustrated embodiment, the deionized water tank 40 outputs fluid, in particular water, to a deionized water polishing pump 44. The deionized water polishing pump 44 in turn outputs the water to a water polishing heat exchanger 46 for polishing and treatment. The water then flows to a deionized water resin tank 48.

Coolant is directed through the electrolysis systems 10, in particular through a deionized water heat exchanger 72 that is fluidically connected to the oxygen separator 14. The coolant used to cool said water may also be subsequently fed to the water polishing heat exchanger 46 via a coolant input 27 for polishing. The coolant is then output back to the deionized water heat exchanger 72 for cooling the water therein.

After the water is output from the deionized water polishing heat exchanger 46 and subsequently to the deionized water resin tank 48, a portion of the water may be fed to deionized water high pressure feed pumps 60. Another portion of the water may be fed to a deionized water pressure control valve 52, as shown in FIG. 1C. The portion of the water that is fed to the deionized water pressure control valve 52 flows through a recirculation fluidic connection 54 that allows the water to flow back to the deionized water tank 40 for continued polishing.

In some embodiments, the electrolysis systems 10 may increase deionized water skid for polishing water flow to flush out ions within the water at a faster rate. The portion of the water that is fed to the deionized water high pressure feed pumps 60 is then output to a deionized water feed 64, which then flows into the oxygen separator 14 for recirculation and eventual re-usage in the electrolyzer cell stacks 11, 12. This process may then continuously repeat.

The electrolysis systems 10 described herein, may be used in stationary and/or immovable power system, such as industrial applications and power generation plants. The electrolysis systems 10 may also be implemented in conjunction with other electrolysis systems 10.

The present electrolysis systems 10 may be comprised in stationary or mobile applications. The electrolysis systems 10 may be in a vehicle or a powertrain 100. A vehicle or powertrain 100 comprising the electrolysis systems 10 may be an automobile, a pass car, a bus, a truck, a train, a locomotive, an aircraft, a light-duty vehicle, a medium-duty vehicle, or a heavy-duty vehicle.

In addition, it may be appreciated by a person of ordinary skill in the art that the electrolysis system 10, electrolyzer stack 11, 12, and/or the electrolyzer cell 80 described in the present disclosure may be substituted for any electrochemical system, such as a fuel cell system, a fuel cell stack, and/or a fuel cell (FC), respectively. As such, in some embodiments, the features and aspects described and taught in the present disclosure regarding electrolysis system 10, electrolyzer stack 11, 12, and/or the electrolyzer cell 80 also relate to a fuel cell system, a fuel cell stack, and/or a fuel cell (FC), respectively. In further embodiments, the features and aspects described or taught in the present disclosure do not relate, and are therefore distinguishable from, those of a fuel cell system, a fuel cell stack, and/or a fuel cell (FC).

As shown in FIG. 1B, the electrolysis system 10 may be a water electrolysis system and may include a capacity factor 132. The capacity factor 132 is the percent of time that electrolysis system 10 operates relative to all hours in a year. Since a levelized cost of hydrogen (LCOH) 140 accounts for all the capital and operating costs of producing hydrogen, the LCOH 140 is sensitive to capital expense (CapEx) of the electrolysis system 134, capital expense (CapEx) for balance of plant 136, (e.g., hydrogen compressor and storage system), and/or any installation, operational, and maintenance expenses 138.

The capital expense (CapEx) of the electrolysis system 134 contributes significantly to LCOH 140 and depends on the capacity factor 132 of the electrolysis system 10. The capacity factor 132 of the electrolysis system 10 may be maximized to minimize LCOH 140 associated with any installation, operational and maintenance expenses 138.

The optimal operating configuration of the electrolyzer cell stacks 11, 12 of the electrolysis system 10 may be dependent on the availability of renewable energy (including cost of electricity) and the capacity factor 132 of the electrolysis system 10. A setpoint may be defined as the set of operating conditions (e.g., operating pressure, operating temperature, capacity factor 132, LCOH 140 etc.) associated with a set of input and/or output requirements (e.g., change in input power, amount of produced hydrogen gas) of the electrolyzer cell stack 11, 12. Though electrolyzer cell stack 11, 12 are responsive units, delays may be incurred when the setpoint is changed because of a change in the operating conditions.

Such delay may be incurred when the electrolysis system 10 includes an array of electrolyzer cell stacks 11, 12 instead of a single unit. The delay may be incurred because of the need to turn each electrolyzer cell stacks 11, 12 on or off as part of a response to changing need and/or renewable energy availability. Not anticipating such delays can result in a decrease in hydrogen production and/or can affect a power balance of stack equipment in the electrolysis system 10 when renewable energy availability is low.

For example, the electrolyzer stack 11, 12 may be able to respond to a single step change in production percentage (%), but may be unable to implement consecutive step changes without one or more advanced control loops. For example, a switch or a change from a 60% system production percentage to a 100% system production percentage may be achieved with the delay required by the system 10 to respond to the change (e.g., quick change and/or significant step change in power demand). In one embodiment, the system production percentage cannot be changed again until the setpoint indicating the new production percentage is stabilized, such as demonstrated by operational and/or functional response of the system 10 (e.g., system production reaches and/or nears new production setpoint).

Certain step changes may require operating more electrolyzers stacks 11, 12 in the electrolysis system 10 and/or operating additional electrolysis systems 10. For example, a step change of 10% or more may require the implementation of one or more additional electrolyzer stacks 11, 12 in the electrolysis system 10. A step change of 10% or less may be accommodated by the existing number of electrolyzers stacks 11, 12 in the electrolysis system 10, such that no additional electrolyzer stacks are required. The percentage (%) step change that may entail the need for an additional electrolyzer stack 11, 12 in the electrolysis system 10 will depend on the design characteristics of the one or more electrolyzers stacks 11, 12 (e.g., maximum power output, power demand, application, etc.).

Several factors may be considered to ensure that the setpoint of the electrolysis system 10 is optimally determined or established. The factors may include cost of electricity, electrolyzer cell stacks 11, 12 efficiency, and electrolyzer cell stacks 11, 12 availability. The electrolyzer cell stacks 11, 12 availability assessment may be based on unavailability due to start-up delays, shut down delays, delays due to changes in operational setpoints, and/or preventative maintenance.

For example, if production is switched or changed from about 10% production to up to about 80% production, the electrolysis system 10 may require some a time period (e.g., a delay) to functionally and stably reach its new setpoint. The time period or delay may depend on the characteristics of the electrolyzer cell stacks 11, 12. In some embodiments, this delay may range from 1 minute to about 1 day, including any time or range of time comprised therein. For example, depending on the characteristics of the electrolyzer cell stacks 11, 12, this delay may range from about 1 minute to about 10 minutes, from about 10 minutes to about 1 hour, from about 1 hour to about 3 hours, from about 3 hours to about 5 hours, from about 5 hours to about 10 hours, from about 10 hours, to about 24 hours. In some embodiments, this delay may be more than 24 hours or less than 1 minute. As a result, there may be a limit to how many times the setpoints can be changed in a given period of time. This limit may depend on the application of the electrolysis system 10 and/or the power demand required. Thus, predicting and/or functionally achieving the first setpoint may be critical to the efficient operation of the electrolysis system 10.

Additionally or alternatively, the electrolyzer cell stacks 11, 12 availability assessment may be based capital expenses (CapEx) of the electrolysis system 134 recovery over the life of equipment (e.g., recovery of the initial expenditure of establishing the electrolysis system 10 over lifetime of the equipment), capital expenses (CapEx) of the balance of plant 136 recovery over the life of equipment (e.g., recovery of the initial expenditure of establishing the balance of plant over lifetime of the equipment), availability of renewable energy (e.g., electricity and/or hydrogen), and/or other customer-specific recovery metrics, as measured against a total cost of ownership and/or operations.

The electrolyzer cell stacks 11, 12 availability assessment may also be based on operations and/or management costs to run the electrolysis system 10. Such operations and/or management costs of any electrolysis system 10 may include costs of replacing major components (e.g. pumps), costs of replacing minor components (e.g. drain valves), costs of replacing disposable components (e.g. resin tanks), cost of electricity to operate the system, and/or cost of routine and/or preventative maintenance (e.g. checking valve timing), as measured against a total cost of ownership and/or operations.

The present disclosure is directed to systems and methods for implementing one or more electrolyzer cell stacks 11, 12 in one or more electrolyzer cell module(s) 144 in an optimal configuration to balance hydrogen production by each electrolyzer cell stacks 11, 12 and/or electrolyzer cell module 144 using a look-ahead forecast model. The look-ahead forecast model 312 can estimate the upcoming renewable energy load and forecast its predictions throughout each day. The look-ahead forecast model 312 can estimate the upcoming renewable energy load and forecast its predictions in real-time. For example, the look-ahead forecast model 312 can make predictions instantaneously and/or as soon as information about the renewable energy is available. The look-ahead forecast model 312 can prepare electrolyzer cell stacks 11, 12 and/or electrolyzer cell modules 144 to maximize hydrogen production.

The number of electrolyzer cell modules 144 that may associated with the present look-ahead forecast model 312 can be any number. For example, the number of electrolyzer cell modules 144 may range from 1 to about 50, including any number or range comprised therein. For example, the number of electrolyzer cell modules 144 can range from 1 to 5, from 5 to 15, from 15 to 25, from 25 to 35, from 35 to 45, or from 45 to 50. In some embodiments, the number of electrolyzer cell modules 144 can be more than 50.

The number of electrolyzer cell stacks 11, 12 in each electrolyzer cell modules 144 can range from 1 to about 50, including any number or range comprised therein. For example, the number of electrolyzer cell stacks 11, 12 in each electrolyzer cell modules 144 can range from 1 to 5, from 5 to 15, from 15 to 25, from 25 to 35, from 35 to 45, or from 45 to 50. In some embodiments, the number of electrolyzer cell stacks 11, 12 in each electrolyzer cell modules 144 can be more than 50. The electrolyzer cell stacks 11, 12 in each electrolyzer cell modules 144 may be the same or may be different.

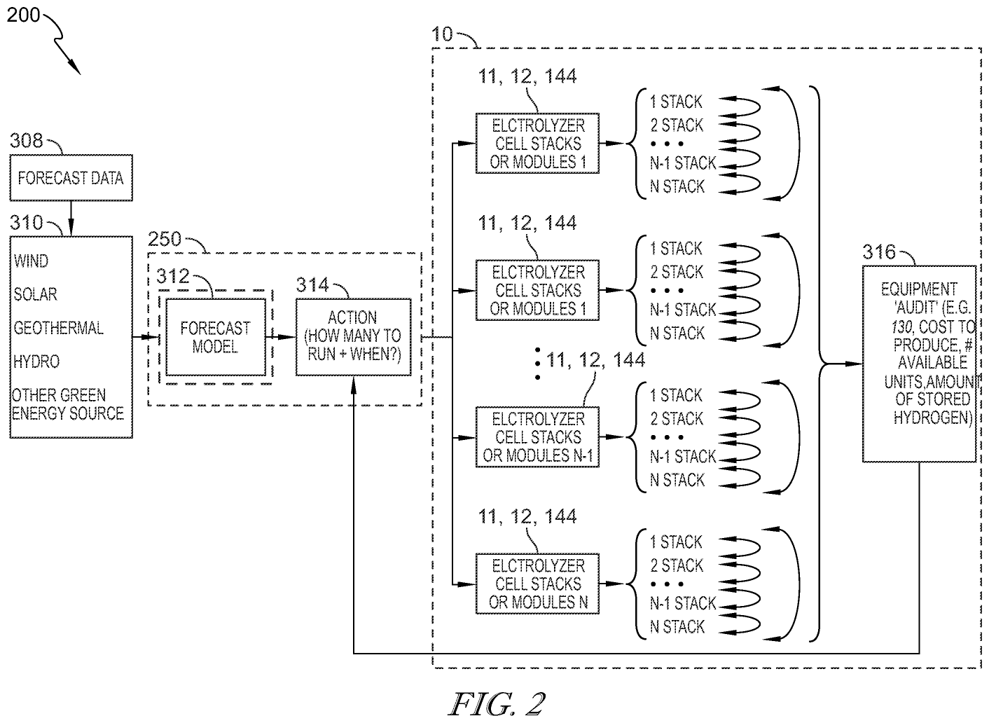

In one embodiment, as shown in FIG. 2, a strategy or method 200 utilizes a look-ahead forecast model 312 to determine, calculate, and/or estimate hydrogen production. The look-ahead forecast model 312 can be used to convert all available renewable energy (RE) 310 into storage if hydrogen production is not required. The available RE 310 can include any combination of wind energy, solar energy, geothermal energy, hydro-energy, and/or any other green energy source. Additionally or alternatively, non-green energy sources may also be used with the look-ahead forecast model 312.

The available RE 310 can be determined or calculated based on forecast data 308 (e.g., weather forecast data). The objective of the strategy or method 200, including the look-ahead forecast model 312, can include minimizing loss and missed production by forecasting available variable RE 310. Minimizing loss and/or minimizing missed production ensures that available variable RE 310 is not lost and better yet, that the available variable RE 310 is converted to hydrogen.

In some embodiments, minimizing loss and/or minimizing missed production ensures that available variable RE 310 may result in a loss of about 30% to about 0% available variable RE 310, including any percentage or range comprised therein. For example, in some embodiments, minimizing loss and/or minimizing missed production ensures that available variable RE 310 may result in a loss of about 30% to about 20%, about 20% to about 10%, about 10% to about 5%, about 5% to about 0% available variable RE 310, including any percentage or range comprised therein.

The look-ahead forecast model 312 can forecast and/or predict available variable RE 310 over a range of about an hour to 14 days, including any time or range of time comprised therein. For example, the look-ahead forecast model 312 can forecast available variable RE 310 over a range about an hour to about a day, from about a day to about 2 days, from about 2 days, to about 4 days, from about 4 days to about 7 days, a from about 7 days to about 14 days, including any time or range of time comprised therein. The look-ahead forecast model 312 can determine, predict, and/or estimate a time range of operation for the electrolyzer cell stacks 11, 12 in each electrolyzer cell module 144 based on the forecasted available variable RE 310.

The look-ahead forecast model 312 may be implemented to use the available variable RE 310 in order to optimize the conversion of renewable electricity (RE) to hydrogen based on several factors. For example, the available variable RE 310 may be calculated as follows.

Available Variable RE=Hydrogen Production+Loss+Missed Production (10)

Loss identified in equation (10) can include any incurred energy loss (e.g. running electrolyzer cell stacks 11, 12 and/or electrolyzer cell modules 144 on standby). Missed production identified in equation (10) can include potential loss due to suboptimal implementation of electrolyzer cell stacks 11, 12 and/or electrolyzer cell modules 144 (e.g. running fewer electrolyzer cell stacks 11, 12 and/or electrolyzer cell modules 144 than the number required to capture all available RE).

As shown in FIG. 2, a controller 250 can determine or implement an action 314 that can result in an operation of the electrolyzer cell stacks 11, 12 and/or electrolyzer cell modules 144 in the electrolysis system 10. The action 314 is dependent on the look-ahead forecast model 312 and/or on one or more equipment audit parameters or characteristics 316 of the electrolysis system 10. The equipment audit parameters 316 can include, but are not limited to capacity factor 132, a cost to produce hydrogen (e.g., levelized cost of hydrogen (LCOH) 140), an amount of stored hydrogen, availability of the electrolyzer cell stacks 11, 12, and/or electrolyzer cell modules 144. The equipment audit parameters 316 can be used to provide a downstream feedback to the look-ahead forecast model 312.

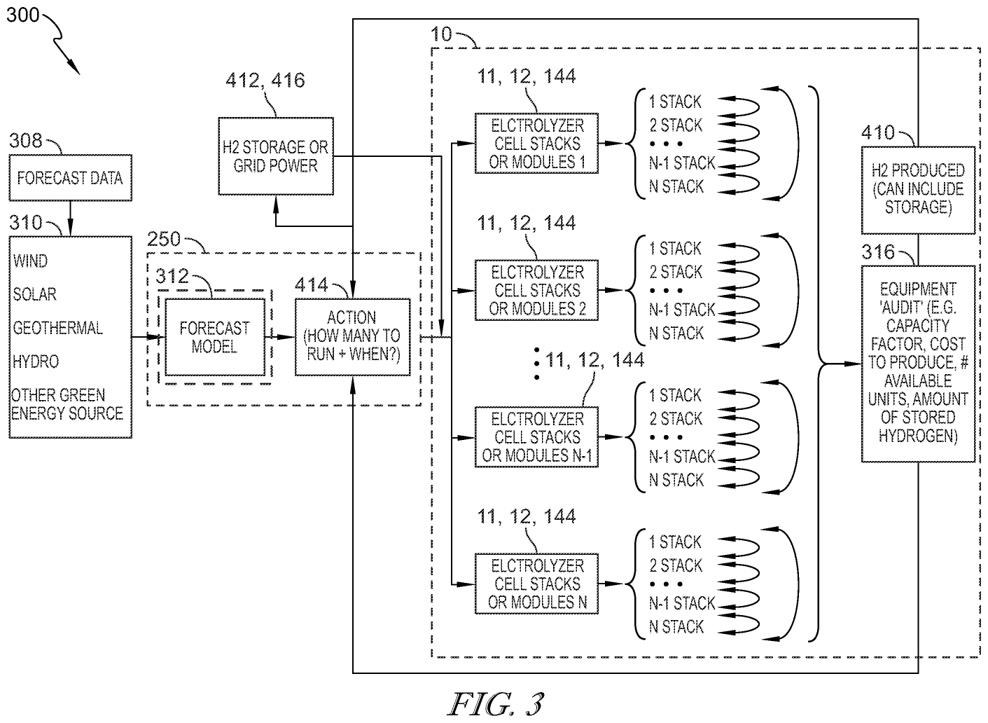

In another embodiment, as shown in FIG. 3, a strategy or method 300 utilizes the look-ahead forecast model 312. This embodiment accounts for a constant hydrogen demand due to a designated process demand when the electrolysis system 10 is operating with both variable RE 310 and a supplementary grid 416. The constant hydrogen demand is based on the designated process demand. For example, the constant hydrogen demand may indicate a certain amount of hydrogen needed, a certain amount of time, and/or a certain power demand for which hydrogen is needed. The strategy or method 300 may include minimizing use of non-green electricity sources for the designated process.

The available RE 310 can include any combination of wind energy, solar energy, geothermal energy, hydro-energy, and/or any other green energy source. The available RE 310 can be determined calculated, and/or estimated based on forecast data 308 (e.g., weather forecast data) and/or the balance of required electricity can be predicted and requested from the supplementary grid 416. Hydrogen that is produced is used to meet the designated process demand of the electrolysis system 10.

Still referring to FIG. 3, the controller 250 can implement or configure an action 414 to determine and/or regulate the operation of the electrolyzer cell stacks 11, 12 and/or the electrolyzer cell modules 144 in the electrolysis system 10. Input into the configuration of the action 414 can also include an assessment of a total hydrogen produced 410 by the electrolysis system 10. Since demand for hydrogen is constant, the controller 250 can determine, predict, and/or estimate if the total hydrogen produced 410 requires a supplemental power (e.g., additional power or power source) to meet the designated process demand. In some embodiments, if supplemental power is required, no hydrogen may be generated since it is expected that the generated hydrogen will be insufficient to meet demand without supplementing power. In some embodiments, the supplemental power may be minimized by converting available RE 310 to hydrogen at the highest efficiency based on the look-ahead forecast model 312.

In some embodiments, if the available RE 310 is in excess of the amount required to meet the required hydrogen needs of the designated process, any excess hydrogen produced may be held and/or stored in a hydrogen storage system 412 for future use. The action 414 is dependent on the look-ahead forecast model 312, the equipment audit parameters or characteristics 316 of the electrolysis system 10, and/or on the total hydrogen produced 410 by the electrolysis system 10. The objective of the action 414 determined and/or implemented by the controller 250 may include identifying if the excess hydrogen stored in the hydrogen storage system 412 (e.g., battery, compressed gas, or liquid hydrogen) or the supplementary grid 416 is required to supplement the available renewable energy 310 to meet the designated process demand.

The action 414 may be based on maximizing the captured RE 310 and minimizing the use of hydrogen from the hydrogen storage system 412 and/or minimizing the utilization of the supplementary grid 416. The action 414 may be based on producing a constant amount of hydrogen irrespective of the available RE 310. Hydrogen production may be calculated, determined or estimated based on several factors. For example, hydrogen production may be calculated as follows:

Constant Hydrogen Production=Available Variable RE+Consumed Storage (11)

Consumed storage identified in equation (11) is the amount of stored hydrogen required to supplement the RE 310 based on hydrogen required for the designated process. As shown in FIG. 3, consumed storage may be equivalent to the supplementary grid 416 power. When RE 310 is insufficient to produce the required volume of hydrogen (e.g., when insufficient hydrogen is produced based on designated process demand), electricity from the supplementary grid 416 can be added to meet the designated process demand. The designated process may be a process including but not limited to ammonia or fertilizer production, chemical industries, synthetic fuel production, metal refineries, electronic industries, metal or glass industries, and food industries.

The look-ahead forecast model 312 can use a risk-based approach. Risk may be a function of impact and/or likelihood. Impact may depend on a potential availability of RE 310 based on a forecast of RE 310 and likelihood may be based on occurrence at predicted levels.

For example, if the RE 310 includes solar energy, and the forecast predicts morning overcast with afternoon clear skies, based on historic records and weather forecasts, there can be about a 40% likelihood of clear skies at about 1:00 pm. Therefore, the look-ahead forecast model 312 can determine or establish that the electrolyzer cell stacks 11, 12 and/or electrolyzer cell modules 144 may need to start-up at an optimized gradual rate to track the transition in weather. All historic data may be continuously and/or periodically updated to improve future predictions.

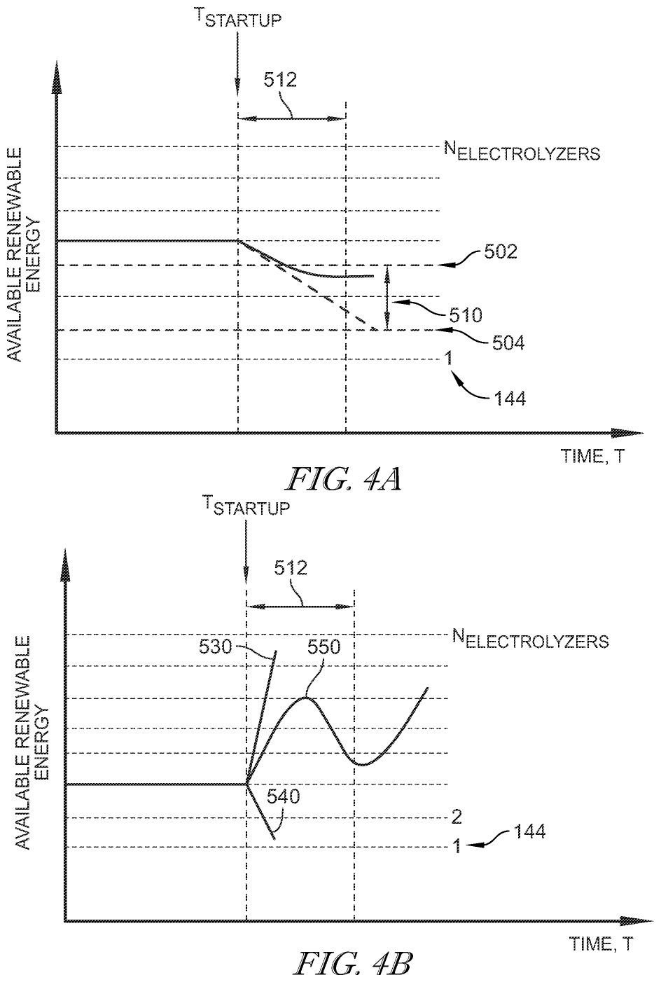

As shown in FIG. 4A, the electrolyzer cell modules 144 operating in the electrolysis system 10 may be changed from a current operation strategy 502 to a new operation strategy 504 based on a manual or sub-optimal prediction of RE 310 by the controller 250 (FIG. 2, 3). When the look-ahead forecast model 312 is not used to change the operation of the electrolyzer cell modules 144 in the electrolysis system 10, there may be some missed production 510. Time to start-up 512 an electrolyzer cell module 144 is typically not accounted for when changing operating strategies and such decisions may result in decision latency.

As shown in FIG. 4B, the electrolyzer cell modules 144 operating in the electrolysis system 10 may be ramped-up and/or ramped-down in response to the look-ahead forecast model 312. The number of operating electrolyzer cell modules 144 as determined, calculated, or established by the controller 250 (FIG. 2, 3), may be based on pre-defined metrics, including customer-specific goals and/or total cost of ownership. Ownership may include maintenance, electricity rates, and/or cost of utilities. The number of operating electrolyzer cell modules 144 may be determined or calculated to avoid a late shutdown of any of the electrolyzer cell modules 144 and to avoid wasting electricity on standby.

Additionally, or alternatively, the number of operating electrolyzer cell modules 144 may be determined, predicted, or estimated by the controller 250 (FIG. 2, 3), to avoid late start-ups and/or to avoid missing out on available RE 310. For example, if the available RE 310 is more than the capacity to produce hydrogen based on the operating electrolyzer cell modules 144, additional electrolyzer cell modules 144 may be started for operation.

In some embodiments, the look-ahead forecast model 312 (FIGS. 2, 3) may also determine or regulate the number of electrolyzer cell stacks 11, 12 that are operating in any given electrolyzer cell modules 144. Each electrolyzer cell stack 11, 12 can operate at a given production percentage ranging from about 5% to about 100%, including any percentage or range of production percentage comprised therein. Additionally, or alternatively, the number of operating electrolyzer cell modules 144 may be determined, regulated, or established to account for change in and/or fluctuations in RE 310 availability.

Referring back to FIG. 4B, if the available RE 310 increases with time, an operation strategy 530 accounts for this increase. Alternatively, if the available RE 310 decreases with time, an operation strategy 540 accounts for this decrease. Alternatively, if the change in the available RE 310 is a composite of an increase available RE 310 and a decrease available RE 310, an operation strategy 550 accounts for the composite change based on the look-ahead forecast model 312.

The controller 250 (see FIGS. 2, 3) may be in communication with a computing device comprising a processor over a network. The computing device may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

The computing device may include one or more of a processor, an input/output (I/O) subsystem, a memory, a data storage device, a communication subsystem, and/or a display that may be connected to each other, in communication with each other, and/or configured to be connected and/or in communication with each other through wired, wireless and/or power line connections and associated protocols (e.g., Ethernet, InfiniBand®, Bluetooth®, Wi-Fi®, WiMAX, 3G, 4G LTE, 5G, etc.).

The computing device may also include additional and/or alternative components, such as those commonly found in a computer (e.g., various input/output devices). In other embodiments, one or more of the illustrative computing device of components may be incorporated in, or otherwise form a portion of, another component. For example, the memory, or portions thereof, may be incorporated in the processor.

The following described aspects of the present invention are contemplated and non-limiting:

A first aspect of the present invention relates to a method of utilizing variable renewable energy. The method comprises using a look-ahead forecast model, which provides an assessment of available renewable energy, determining an operation of one or more electrolyzer cell stacks in an electrolysis system to produce hydrogen by a controller which uses the look-ahead forecast model in real-time, and determining a time range of operation of each of the one or more electrolyzer cell stacks in the electrolysis system.

A second aspect of the present invention relates to a system for utilizing available renewable energy. The system comprises a controller in communication with a look-ahead forecast model, an electrolysis system including one or more electrolyzer stacks, and a hydrogen storage system to store any excess hydrogen produced. The operation of the one or more electrolyzer stacks is determined by the controller based on a look-ahead forecast model.

In the first aspect of the present invention, the look-ahead forecast model may be used to assess wind energy, solar energy, geothermal energy, hydro energy, or any combination thereof.

In the first aspect of the present invention, the method may further comprise minimizing loss or missed production. In the first aspect of the present invention, minimizing loss may comprise minimizing energy loss. In the first aspect of the present invention, minimizing missed production may comprise minimizing potential loss due to suboptimal implementation of the one or more electrolyzer cell stacks.

In the first aspect of the present invention, the method may further comprise using the look-ahead forecast model for forecasting available variable energy over a period of about 14 days. In the first aspect of the present invention, the method may further comprise the controller determining the operation of the one or more electrolyzer cell stacks based on a characteristic of the electrolysis system. The characteristic of the electrolysis system may include one or more of capacity factor, cost to produce hydrogen, and availability of the electrolyzer cell stacks.

In the first aspect of the present invention, the method may further comprise the controller determining the operation of the one or more electrolyzer cell stacks based on a constant hydrogen demand due to a designated process. In the first aspect of the present invention, the method may further comprise the controller determining if excess hydrogen is being produced, and storing excess hydrogen produced in a hydrogen storage system. In the first aspect of the present invention, the method may further comprise the controller determining if excess hydrogen is being produced based on the constant hydrogen demand due to the designated process.

In the first aspect of the present invention, the method may further comprise the controller operating the one or more electrolyzer cell stacks in the electrolysis system based on the excess hydrogen stored in the hydrogen storage system.

In the first aspect of the present invention, the method may further comprise the controller determining if insufficient hydrogen is being produced, and supplementing the hydrogen with stored hydrogen, or by adding electricity from a supplementary grid to produce a balance of hydrogen required. In the first aspect of the present invention, the method may further comprise the controller determining if excess hydrogen is being produced based on the constant hydrogen demand due to the designated process, and minimizing utilizing supplementary grid if excess hydrogen is being produced. In the first aspect of the present invention, the method may further comprise the controller determining if excess hydrogen is being produced based on a downstream feedback from an equipment audit.

In the first aspect of the present invention, downstream feedback from the equipment audit may comprise parameters including capacity factor, cost to produce hydrogen, availability of the electrolyzer cell stacks, or amount of stored hydrogen.

In the first aspect of the present invention, the method may further comprise the controller operating the one or more electrolyzer cell stacks to avoid a late start-up or to avoid missing out on the available renewable energy. In the first aspect of the present invention, the method may further comprise the controller operating the one or more electrolyzer cell stacks to account for a change in renewable energy availability.

In the second aspect of the present invention, the operation of the one or more electrolyzer stack in the system may be determined by the controller based on a constant hydrogen demand due to a designated process.

In the second aspect of the present invention, the system may further comprises access to a power grid for the supply of supplementary power.

In the second aspect of the present invention, the controller may further determine operation of the one or more electrolyzer cell stacks to account for changes in renewable energy availability.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method of utilizing a variable renewable energy comprising:
using a look-ahead forecast model that provides an assessment of an available renewable energy,
measuring an operation of one or more electrolyzer cell stacks in an electrolysis system to produce hydrogen by a controller that uses the look-ahead forecast model in real-time, and
determining a time range of operation of each of the one or more electrolyzer cell stacks in the electrolysis system.

2. The method of claim 1, wherein the look-ahead forecast model assesses wind energy, solar energy, geothermal energy, hydro-energy, or any combination thereof.

3. The method of claim 1, further comprising minimizing loss or minimizing missed production.

4. The method of claim 3, wherein minimizing loss comprises minimizing available renewable energy loss and minimizing missed production comprises minimizing potential loss due to suboptimal implementation of the one or more electrolyzer cell stacks.

5. The method of claim 1, further comprising using the look-ahead forecast model for forecasting available variable energy over a period of about 14 days.

6. The method of claim 1, further comprising the controller determining the operation of the one or more electrolyzer cell stacks based on a characteristic of the electrolysis system, wherein the characteristic of the electrolysis system includes one or more of a capacity factor, a cost to produce hydrogen, and an availability of the electrolyzer cell stacks.

7. The method of claim 1, comprising the controller determining the operation of the one or more electrolyzer cell stacks based on a constant hydrogen demand due to a designated process demand.

8. The method of claim 7, comprising the controller determining if an excess hydrogen is being produced, and storing the excess hydrogen produced in a hydrogen storage system.

9. The method of claim 8, comprising the controller determining if the excess hydrogen is being produced based on the constant hydrogen demand due to the designated process.

10. The method of claim 8, comprising the controller operating the one or more electrolyzer cell stacks in the electrolysis system based on the excess hydrogen stored in the hydrogen storage system.

11. The method of claim 7, comprising the controller determining if insufficient hydrogen is being produced, supplementing the hydrogen with stored hydrogen or adding electricity from a supplementary grid to produce a balance of hydrogen.

12. The method of claim 7, comprising the controller determining if the excess hydrogen is being produced based on the constant hydrogen demand due to the designated process and minimizing utilizing a supplementary grid when the excess hydrogen is being produced.

13. The method of claim 7, comprising the controller determining if the excess hydrogen is being produced based on a downstream feedback from an equipment audit.

14. The method of claim 13, wherein the downstream feedback from the equipment audit comprises parameters including a capacity factor, a cost to produce hydrogen, an availability of the electrolyzer cell stacks, or an amount of stored hydrogen.

15. The method of claim 1, comprising the controller operating the one or more electrolyzer cell stacks to avoid a late start-up or to avoid missing out on the available renewable energy.

16. The method of claim 1, comprising the controller operating the one or more electrolyzer cell stacks to account for a change in renewable energy availability.

17. A system for utilizing available renewable energy comprising:
a controller in communication with a look-ahead forecast model,
an electrolysis system including one or more electrolyzer stacks, and
a hydrogen storage system to store an excess hydrogen produced,
wherein the controller is configured to operate the one or more electrolyzer stacks based on the look-ahead forecast model.

18. The system of claim 17, wherein operation of the one or more electrolyzer stacks by the controller further comprises a constant hydrogen demand due to a designated process.

19. The system of claim 17, wherein the system further comprises access to a power grid to supply supplementary power.

20. The system of claim 17, wherein the controller further regulates operation of the one or more electrolyzer cell stacks to account for changes in renewable energy availability.
